(19) United States
(12) Patent Application Publication
(10) Pub. No.: US 2025/0256243 A1
(43) Pub. Date: Aug. 14, 2025

(54) EXHAUST GAS PURIFICATION DEVICE

(71) Applicant: TOYOTA JIDOSHA KABUSHIKI KAISHA, Toyota-shi (JP)

(72) Inventor: Norio ISHIKAWA, Toyota-shi (JP)

(73) Assignee: TOYOTA JIDOSHA KABUSHIKI KAISHA, Toyota-shi (JP)

(21) Appl. No.: 18/981,977

(22) Filed: Dec. 16, 2024

(30) Foreign Application Priority Data
Feb. 9, 2024 (JP) 2024-018634

(51) Int. Cl. B01D 53/94; B01J 27/224; B01J 35/57

(52) U.S. Cl. CPC B01D 53/9454; B01D 53/945; B01J 27/224; B01J 35/57; B01D 2255/702; B01D 2258/01

(57) ABSTRACT

An exhaust gas purification device includes a catalyst converter purifying exhaust gas from an exhaust manifold. The catalyst converter includes a metal porous body through which exhaust gas from the exhaust manifold passes, and an exhaust gas purification catalyst purifying exhaust gas passing through the porous body. The exhaust gas purification catalyst is electrically heated, with a pair of electrodes attached to a catalyst main body. Through-holes are formed in the porous body along the exhaust gas from upstream to downstream. Metal material is exposed on a surface of the porous body. Under a temperature environment of 25° C., a ratio of a heat capacity of the porous body to that of the catalyst main body is 8% or greater and 23% or smaller.

### CROSS REFERENCE TO RELATED APPLICATIONS

The present application claims priority from Japanese patent application JP 2024-018634 filed on Feb. 9, 2024, the entire content of which is hereby incorporated by reference into this application.

### BACKGROUND

### Technical Field

The present disclosure relates to an exhaust gas purification device.

### Background Art

For purification of an exhaust gas discharged from an engine, an exhaust gas purification device is connected to an exhaust manifold. The exhaust gas purification device includes an exhaust gas purification catalyst for purifying the exhaust gas from the exhaust manifold. The exhaust gas purification catalyst includes a metal catalyst that purifies the exhaust gas and a carrier (catalyst carrier) that carries the metal catalyst.

For example, as such an exhaust gas purification device, JP 2019-019817 A proposes a device including a catalyst converter. The catalyst converter includes a first catalyst that purifies the exhaust gas from the exhaust manifold, and a second catalyst that purifies the exhaust gas that has passed through the first catalyst. Here, the heat capacity of the first catalyst is smaller than that of the second catalyst. According to this catalyst converter, it is possible to raise the temperature of the first catalyst at an early stage and improve the exhaust performance at the time of starting engine.

### SUMMARY

However, when a vehicle is rapidly accelerated, for example, the flow rate of the exhaust gas increases, and the exhaust gas passing through the first catalyst is rapidly heated by activation of the catalyst. As a result, when the exhaust gas with the temperature rapidly increased reaches the second catalyst, the exhaust gas purification catalyst as the second catalyst may be rapidly heated in some cases. It is assumed that as a result of the above, a thermal shock acts on the exhaust gas purification catalyst and thus generates cracks in the exhaust gas purification catalyst.

The present disclosure has been made in view of the above problem, and provides a catalyst purification device capable of suppressing generation of cracks in the exhaust gas purification catalyst by reducing the thermal shock acting on the exhaust gas purification catalyst.

In view of the above problem, an exhaust gas purification device according to the present disclosure includes: a catalyst converter that purifies an exhaust gas from an exhaust manifold. The catalyst converter includes a porous body made of a metal material through which the exhaust gas from the exhaust manifold passes, and an exhaust gas purification catalyst that purifies the exhaust gas that passes through the porous body. The exhaust gas purification catalyst is an electrically heated catalyst, with a pair of electrodes attached to a catalyst main body. A plurality of through-holes is formed in the porous body along the exhaust gas from upstream to downstream. The metal material is exposed on a surface of the porous body. Under a temperature environment of 25° C., a ratio of a heat capacity of the porous body to the heat capacity of the catalyst main body is equal to or greater than 8% and equal to or smaller than 23%.

According to the present disclosure, it is possible to suppress generation of cracks in the exhaust gas purification catalyst by reducing a thermal shock acting on the exhaust gas purification catalyst.

### BRIEF DESCRIPTION OF THE DRAWINGS

FIG. 1 is a schematic conceptual view for explaining an exhaust gas purification device according to the present embodiment;

FIG. 2 is a schematic perspective view of a first catalyst converter of the exhaust gas purification device shown in FIG. 1;

FIG. 3A is a schematic plan view of a porous body shown in FIG. 2;

FIG. 3B is a modification of the porous body shown in FIG. 3A;

FIG. 4 is a graph showing a relationship among a bed temperature, a temperature of an exhaust gas passing through the first catalyst converter, and a crack generated in the exhaust gas purification catalyst when the first catalyst converter according to Examples 1 and 2 and Comparative Examples 1 and 2 is used;

FIG. 5A is a graph showing a relationship between a ratio of the heat capacity and an amount of reduction in speed of temperature increase of the first catalyst converter according to Examples 1 and 2 and Comparative Examples 1 and 2; and

FIG. 5B is a graph showing a relationship between the ratio of the heat capacity and a rate of increase in pressure loss of the first catalyst converter according to Examples 1 and 2 and Comparative Examples 1 and 2.

### DETAILED DESCRIPTION

### First Embodiment

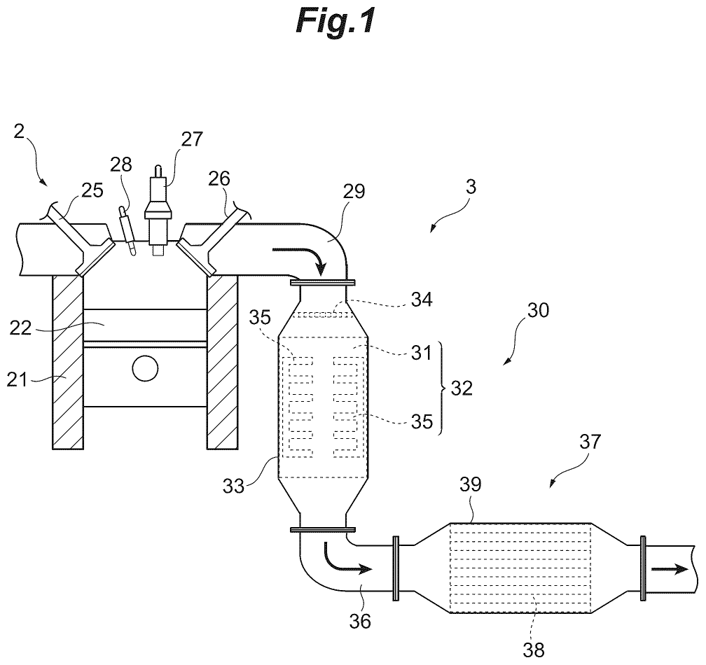

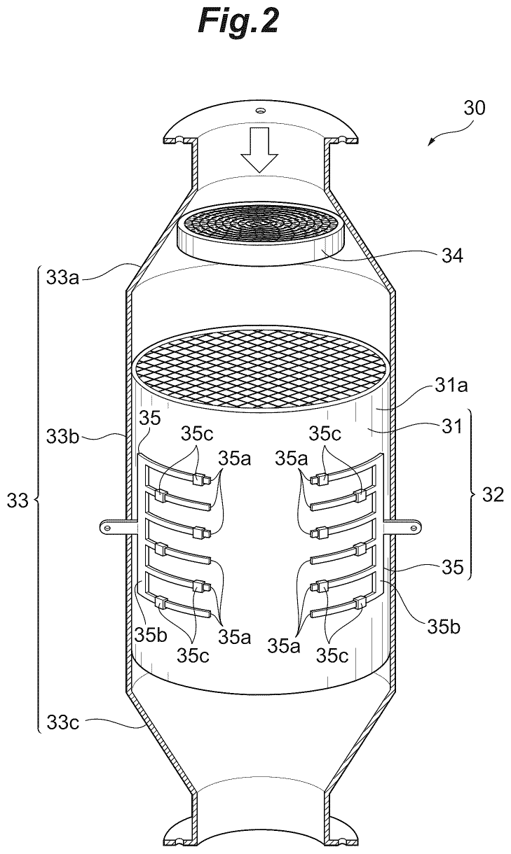

Hereinafter, an exhaust gas purification device according to an embodiment of the present disclosure will be described with reference to FIGS. 1 to 5. FIG. 1 is a schematic conceptual view for explaining an exhaust gas purification device 3 according to the embodiment of the present disclosure, and FIG. 2 is a schematic perspective view of a first catalyst converter 30 of the exhaust gas purification device 3 shown in FIG. 1. In FIG. 2, in order to show the inside of the first catalyst converter 30, a housing 33 is shown in half.

As shown in FIG. 1, the exhaust gas purification device 3 according to the present embodiment is a device that is attached downstream of an engine 2 and that purifies an exhaust gas after combustion in the engine 2. The engine 2 may be either a gasoline engine or a diesel engine, and in the present embodiment, a gasoline direct injection engine is illustrated as an example in FIG. 1.

In the engine 2, air sucked via an intake valve 25 flows into a combustion chamber formed of a cylinder block 21 and a piston 22, and is mixed with fuel (gasoline) injected by a fuel injection valve 28. The mixed air-fuel mixture is ignited by a spark plug 27 and combusted in the combustion chamber, and the exhaust gas after combustion is discharged from an exhaust manifold 29 via an exhaust valve 26.

The exhaust gas exhausted in the exhaust manifold 29 is purified in the exhaust gas purification device 3. Specifically, the exhaust gas purification device 3 includes the first catalyst converter 30 connected to the exhaust manifold 29 and a second catalyst converter 37 downstream of and connected to the first catalyst converter 30 via an exhaust pipe 36. The first catalyst converter 30 is arranged, for example, in an engine room (not shown) of a vehicle, and the second catalyst converter 37 is arranged, for example, under a floor (not shown) of a vehicle.

The first catalyst converter 30 includes a porous body 34 made of a metal material through which the exhaust gas from the exhaust manifold 29 passes, an exhaust gas purification catalyst 32 that purifies the exhaust gas from the exhaust manifold 29, and the housing 33 that houses the exhaust gas purification catalyst 32. Likewise, the second catalyst converter 37 includes an exhaust gas purification catalyst 38 that further purifies the exhaust gas that cannot be completely purified by the first catalyst converter 30 and a housing 39 that houses the exhaust gas purification catalyst 38. The porous body 34 and the housings 33, 39 are made of a metal material, such as, stainless steel, carbon steel, or aluminum.

As shown in FIG. 2, the exhaust gas purification catalyst 32 is an electrically heated catalyst with a pair of electrodes 35, 35 attached to a catalyst main body 31. The catalyst main body 31 has a cylindrical shape in a honeycomb structure. Each electrode 35 is in a comb shape and has a plurality of wiring portions 35a extending circumferentially around the catalyst main body 31. The plurality of wiring portions 35a is fixed by means of fixing portions 35c so as to be spaced apart from each other in the axial direction of the catalyst main body 31. The plurality of wiring portions 35a of each electrode 35 is coupled together by means of a coupling portion 35b. By supplying the pair of electrodes 35 with current, the catalyst main body 31 can be resistively heated so that the metal catalyst of the exhaust gas purification catalyst 32 can be activated.

In the housing 33 of the first catalyst converter 30, an inlet side cone portion 33a, a body portion 33b, and an outlet side cone portion 33c are formed. The inlet side cone portion 33a is in a cone shape where the exhaust gas from the exhaust manifold 29 flows in and where a cross-section of a flow path of the exhaust gas enlarges from upstream toward downstream of the exhaust gas. The body portion 33b is formed so as to be continuous with the inlet side cone portion 33 on the upstream side of the exhaust gas flow and has a cylindrical shape in which the cross-section of the flow path of the exhaust gas is constant. The outlet side cone portion 33c is formed so as to be continuous with the body portion 33b on the upstream side of the exhaust gas flow and is in a cone shape where the cross-section of the flow path of the exhaust gas reduces from upstream toward downstream of the exhaust gas. In the present embodiment, the porous body 34 is disposed inside the inlet side cone portion 33a and the exhaust gas purification catalyst 32 is disposed inside the body portion 33b. This allows an axial center of the porous body 34 in a disk shape to align with an axial center of the exhaust gas purification catalyst 32. As a result, the exhaust gas that has passed through the porous body 34 and the heat of which has been absorbed can be made to uniformly flow into the exhaust gas purification catalyst 32.

In the present embodiment, since the engine 2 is a gasoline engine, the exhaust gas purification catalyst 32 is a three-way catalyst for purifying hydrocarbon (HC), carbon monoxide (CO), and nitride oxide (NOx) of the exhaust gas from the gasoline engine. Meanwhile, when the internal combustion engine is a diesel engine, the exhaust gas purification catalyst 32 is an oxidation catalyst that removes carbon monoxide (CO), hydrocarbon (HC), and the like. Note that the exhaust gas purification catalyst 38 housed in the second catalyst converter 37 is also provided with the same catalyst as that of the exhaust gas purification catalyst 32 in accordance with the type of the internal combustion engine.

In the catalyst main body 31 of the exhaust gas purification catalyst 32, a metal catalyst that purifies the exhaust gas is carried on a carrier (catalyst carrier). A carrier 31a is in a honeycomb shape. A plurality of through-holes extending along an axial center of the carrier 31a is formed. The carrier 31a is made of a ceramic material, the examples of which may include a porous ceramic material containing any one type of alumina, zirconia, cordierite, titania, silicon carbide, and silicon nitride as a main component. The same holds true for the carrier of the exhaust gas purification catalyst 38.

In the present embodiment, the carrier 31a is made of a SiC-based ceramic material. The SiC-based ceramic material is a material having SiC as a main material. Other ceramic materials may be further contained as long as the conductivity of the carrier 31a can be secured. In the present embodiment, since the carrier 31a is made of the SiC-based ceramic material, the catalyst main body 31 can be supplied with current through the electrode 35. A metal catalyst containing at least one type of platinum, rhodium, and palladium is carried on a wall surface forming the honeycomb structure of the carrier 31a. When the carrier carries the metal catalyst, such a carrier can be obtained by coating a carrier with slurry containing the aforementioned ceramic material and metal catalyst and firing the coated carrier.

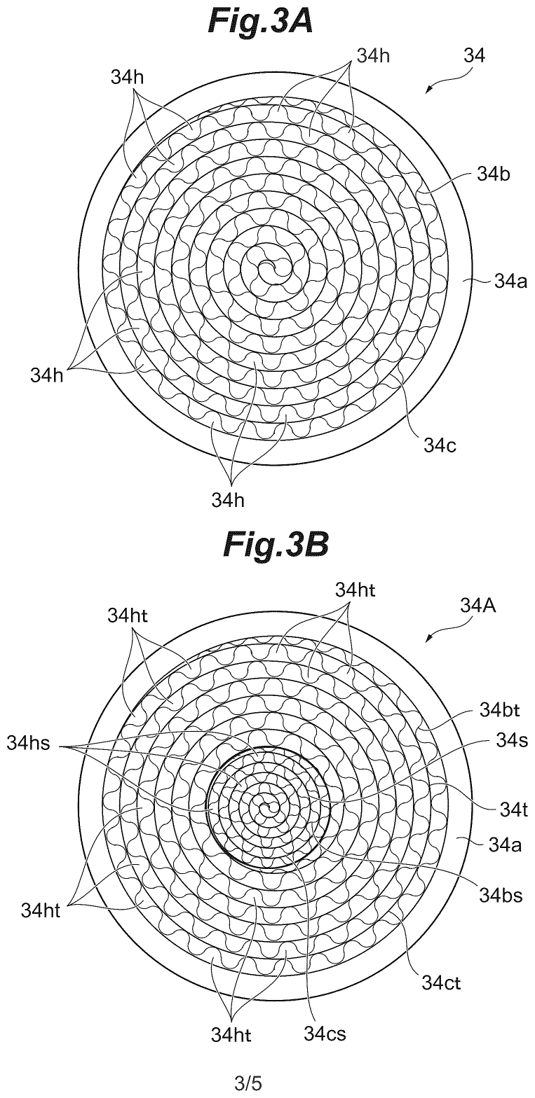

As shown in FIG. 3A, a carrier of the porous body 34 is in a disk shape and is a structure in which a plurality of through-holes through which the exhaust gas passes is formed inside a metal frame body (outer peripheral portion) 34a in a ring shape. Specifically, a metal strip 34b bent in a wavy shape and a metal strip 34c in a plate shape are wound in a superimposed manner inside the metal frame body 34a. In this manner, a plurality of through-holes 34h is formed in the porous body 34 along the exhaust gas from upstream toward downstream.

In the present embodiment, the heat capacity of the porous body 34 is smaller than the heat capacity of the catalyst main body 31. Specifically, under a temperature environment of 25° C., the ratio of the heat capacity of the porous body 34 to that of the catalyst main body 31 is equal to or greater than 8% and equal to or smaller than 23%. For example, the heat capacity of the catalyst main body 31 is in a range of 184 to 322 J/K under the temperature environment of 25° C. The heat capacity of the porous body 34 is in a range of 14.7 to 74.1 J/K under the temperature environment of 25° C. The heat capacities in these ranges are those of catalysts applied in accordance with the displacements of engines of typical vehicles on the market, and the heat capacities can be made to fit within the ranges by appropriately selecting the aforementioned materials and the like.

According to the present embodiment, the exhaust gas flowing into the first catalyst converter 30 from the exhaust manifold 29 passes through the porous body 34, reaches the exhaust gas purification catalyst 32, and is purified by the exhaust gas purification catalyst 32. Since the exhaust gas purification catalyst 32 is an electrically heated catalyst, at the start of the engine 2, current is supplied between the pair of electrodes 35 so that the exhaust gas purification catalyst 32 can be heated. This activates the heated exhaust gas purification catalyst 32 at an early stage, even if an exhaust gas with a relatively low-temperature reaches the exhaust gas purification catalyst 32 at the start of the engine 2. As a result, the purification efficiency of the exhaust gas can be increased from the start of the engine 2.

On the other hand, when a vehicle is rapidly accelerated or the like, the engine speed of the engine 2 increases, and the exhaust gas with a relatively high-temperature flows into the first catalyst converter 30 from the exhaust manifold 29. Further, since the exhaust gas flowing into the exhaust manifold 29 increases, the activation of the exhaust gas purification catalyst 32 is also increased, thereby facilitating rapid increase in temperature.

In the present embodiment, even in such a state, since the metal material is exposed on the surface of the porous body 34, the heat of the exhaust gas with a relatively high-temperature flowing into the first catalyst converter 30 can be absorbed by the porous body 34. As a result, excessive activation of the exhaust gas purification catalyst 32 disposed downstream of the exhaust gas can be suppressed. Consequently, the thermal shock acting on the exhaust gas purification catalyst 32 is reduced so that generation of cracks in the exhaust gas purification catalyst 32 can be suppressed. For exhibiting such an advantageous effect, the ratio of the heat capacity of the porous body 34 to that of the catalyst main body 31 is equal to or greater than 8% under the temperature environment of 25° C. according to the later-described experiments or the like conducted by the inventors. Further, since the pressure loss of the exhaust gas passing through the porous body 34 increases as the ratio of the heat capacity increases, the ratio of the heat capacity of the porous body 34 to that of the catalyst main body 31 is equal to or smaller than 23%. The appropriate range of the ratio of the heat capacity is described in the following examples.

Further, as shown in FIG. 3B, in a plan view of a porous body 34A, the heat capacity per unit area in a circular center region 34s of the porous body 34A is greater than the heat capacity per unit area in a doughnut-shaped surrounding region 34t that surrounds the center region 34s. The “heat capacity per unit area” is a value obtained by dividing the entire heat capacity of a region under the temperature environment of 25° C. by the area of the region in a plan view. The flow velocity of the exhaust gas flowing toward the center region 34s is higher and the flow rate of the exhaust gas is also higher as compared to the surrounding region 34t. Therefore, by increasing the heat capacity in the center region 34s, the heat of the exhaust gas passing through the center region 34s can be efficiently absorbed. Accordingly, the temperature increase at the center of the exhaust gas purification catalyst 32 in a plan view can be suppressed, thereby enabling the thermal shock on the catalyst main body 31 to be reduced.

More specifically, in the carrier of the porous body 34A, a metal strip 34bt (34bs) bent in a wavy shape and a metal strip 34ct (34cs) in a plate shape are wound in a superimposed manner inside the metal frame body 34a in a circular ring shape. The wave-pitch of the metal strip 34bs in the center region 34s is greater than that of the metal strip 34bt in the surrounding region 34t. Thus, in a plan view of the porous body 34, an opening area of a through-hole 34hs formed in the center region 34s is smaller than an opening area of a through-hole 34ht formed in the surrounding region 34t. Further, the number of the through-holes 34hs per unit area in the center region 34s is larger than the number of the through-holes 34ht per unit area in the surrounding region 34t. In this manner, in addition to the aforementioned advantageous effects, the opening area of the through-hole 34hs in the center region 34s is reduced and the number of the through-holes 34hs is correspondingly increased so that the pressure loss of the exhaust gas can be reduced while securing the heat capacity in the center region 34s.

### EXAMPLES

Examples of the present disclosure will be described below.

### Example 1

As shown below, the first catalyst converter 30 shown in FIG. 2 was prepared. As the porous body 34, a porous body in a disk shape made of stainless steel having a diameter of 70 mm and a length of 10 mm was prepared. The thickness of the metal frame body 34a in a ring shape was 1.0 mm. The thickness of the metal strip 34b in a wavy shape and the metal strip 34c in a plate shape was 30 um. The number of cells (the number of through-holes) per square inch of the porous body 34 was 600. The mass of the porous body 34 was 41.0 g. The heat capacity of the porous body 34 was 18.9 K/J under a temperature environment of 25° C. Next, as a metal catalyst, slurry of ceria-zirconia containing a predetermined percentage of rhodium particles was coated on a SiC substrate (carrier), dried, and then calcined. The mass of the catalyst main body 31 obtained as such was 244 g. The heat capacity of the catalyst main body 31 was 174 K/J under the temperature environment of 25° C. The ratio of the heat capacity of the porous body 34 to that of the catalyst main body 31 was 11% under the temperature environment of 25° C.

### Example 2

The first catalyst converter 30 was prepared in the same manner as in Example 1. The difference from Example 1 is that the length of the porous body 34 was set to be 15 mm. The mass of the porous body 34 was 62.0 g. The heat capacity of the porous body 34 was 28.6 K/J under the temperature environment of 25° C.

### Comparative Example 1

The first catalyst converter was prepared in the same manner as in Example 1. The difference from Example 1 is that the porous body 34 was not provided.

### Comparative Example 2

The first catalyst converter was prepared in the same manner as in Example 1. The difference from Example 1 is that the length of the porous body 34 was set to be 5 mm. The mass of the porous body 34 was 21.0 g. The heat capacity of the porous body 34 was 9.7 K/J under the temperature environment of 25° C.

### Evaluation Test

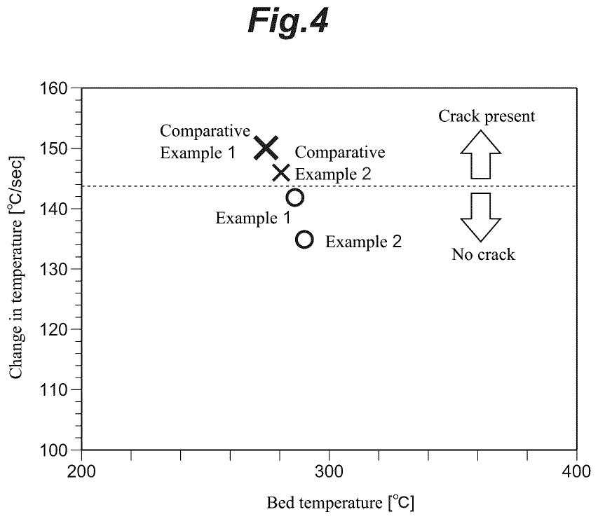

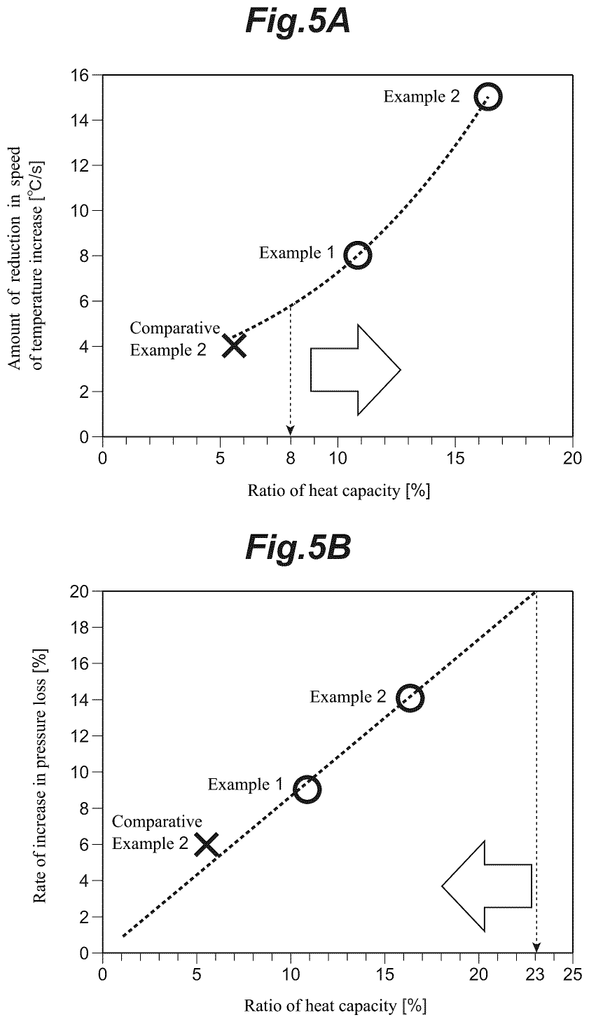

The first catalyst converter of each of Examples 1 and 2 and Comparative Examples 1 and 2 was connected to an exhaust pipe having a bypass path from an engine having a displacement of 2.5 L. Then, a test under a condition of rapid acceleration of 500 cycles was conducted, by setting, as one cycle, a process of changing the engine speed from 1000 rpm to 3000 rpm. At this time, whether cracks have been generated in the catalyst main body was checked. In addition, the bed temperature of the catalyst main body and change in temperature (the maximum speed of temperature increase) at a position downstream of the porous body by 5 mm were measured. The results are shown in FIG. 4 and Table 1. Next, the amount of reduction in speed of temperature increase of Examples 1 and 2 and Comparative Example 2 was measured on the basis of the maximum speed of temperature increase of Comparative Example 1. The results are shown in Table 1 below and FIG. 5A. The rate of increase in pressure loss of Examples 1 and 2 and Comparative Example 2 was measured on the basis of the pressure loss of the exhaust gas of Comparative Example 1. The results are shown in Table 1 and FIG. 5B below. Furthermore, as a reference example, the test under the condition of rapid acceleration of 500 cycles was conducted on the catalyst converter of Comparative Example 1, by setting, as one cycle, a process of changing the engine speed from 1000 rpm to 2900 rpm. The aforementioned results are shown in Table 1.

TABLE 1

| | Porous body | | Condition | Maximum | | |
|---|---|---|---|---|---|---|
| | | Ratio of | of rapid | speed of | | Pressure |
| | | heat | acceleration | temperature | | loss |
| | Size (mm) | capacity | of 500 cycles | increase ° C./s | Crack | increase |
| Example 1 | φ70 × L10 | 11% | 1000 rpm | 142(▴8) | None | 9% |
| | | | →3000 rpm | | | |
| Example 2 | φ70 × L15 | 16% | 1000 rpm | 135(▴15) | None | 14% |
| | | | →3000 rpm | | | |
| Comparative | None | | 1000 rpm | 150 | Present | None |
| Example 1 | | | →3000 rpm | | | |
| Reference | None | | 1000 rpm | 137 | None | None |
| Example | | | →2900 rpm | | | |
| Comparative | φ70 × L5 | 6% | 1000 rpm | 146(▴4) | Present | 6% |
| Example 2 | | | →3000 rpm | | | |

### Results and Consideration

No crack was generated in the catalyst main body of Examples 1 and 2, while cracks were generated in the catalyst main body of Comparative Examples 1 and 2. As a reason for this, it is assumed that since under the condition of rapid acceleration, the heat of the exhaust gas was sufficiently absorbed by the porous body in Examples 1 and 2, no crack was generated in the catalyst main body of Examples 1 and 2. Further, it is assumed that when the engine speed was changed from 1000 rpm to 2900 rpm as in the reference example, the temperature of the exhaust gas was low and the flow rate of the exhaust gas was also low, and therefore, even with the use of the catalyst converter of Comparative Example 1, no crack was generated in the catalyst main body. Considering such points, for preventing generation of cracks in the catalyst main body, the ratio of the heat capacity of the porous body to that of the catalyst main body is equal to or greater than 8% as shown in FIG. 5A, and more preferably, equal to or greater than 11%. Further, as shown in FIG. 5B, considering the pressure loss of the porous body, the ratio of the heat capacity of the porous body to that of the catalyst main body is equal to or smaller than 23%, and more preferably equal to or smaller than 16%.

What is claimed is:

1. An exhaust gas purification device comprising a catalyst converter that purifies an exhaust gas from an exhaust manifold, wherein
the catalyst converter includes a porous body made of a metal material through which the exhaust gas from the exhaust manifold passes, and an exhaust gas purification catalyst that purifies the exhaust gas that passes through the porous body,
the exhaust gas purification catalyst is an electrically heated catalyst, with a pair of electrodes attached to a catalyst main body,
a plurality of through-holes is formed in the porous body along the exhaust gas from upstream to downstream, and the metal material is exposed on a surface of the porous body, and
under a temperature environment of 25° C., a ratio of a heat capacity of the porous body to the heat capacity of the catalyst main body is equal to or greater than 8% and equal to or smaller than 23%.

2. The exhaust gas purification device according to claim 1, wherein
the catalyst converter comprises a housing made of metal that houses the porous body and the exhaust gas purification catalyst,
in the housing, an inlet side cone portion where the exhaust gas from the exhaust manifold flows in and where a cross-section of a flow path of the exhaust gas enlarges from upstream toward downstream of the exhaust gas, a body portion that is continuous with the inlet side cone portion and where the cross-section of the flow path of the exhaust gas is constant, and an outlet side cone portion that is continuous with the body portion and where the cross-section of the flow path of the exhaust gas reduces from upstream toward downstream of the exhaust gas are formed,
the porous body is disposed inside the inlet side cone portion, and
the exhaust gas purification catalyst is disposed inside the body portion.

3. The exhaust gas purification device according to claim 2, wherein
the porous body is disk-shaped, and
in a plan view of the porous body, a heat capacity per unit area in a center region of the porous body is greater than the heat capacity per unit area in a surrounding region that surrounds the center region.

4. The exhaust gas purification device according to claim 3, wherein
in the plan view of the porous body, an opening area of each through-hole formed in the center region is smaller than the opening area of each through-hole formed in the surrounding region, and
a number of the through-holes per unit area in the center region is greater than the number of the through-holes per unit area in the surrounding region.

5. The exhaust gas purification device according to claim 1, wherein the catalyst main body comprises a carrier in a honeycomb shape made of a SiC-based ceramic material.
